(19) United States
(12) Patent Application Publication
(10) Pub. No.: US 2012/0292926 A1
(43) Pub. Date: Nov. 22, 2012

(54) SLIDING HANDLE LOCK FOR DOOR AND WINDOW

(75) Inventor: GONGCHUN ZHANG, GUANGZHOU CITY (CN)

(73) Assignee: CMECH (GUANGZHOU) INDUSTRIAL LTD.

(21) Appl. No.: 13/192,550

(22) Filed: Jul. 28, 2011

(30) Foreign Application Priority Data
May 20, 2011 (CN) 201120164047.3

(51) Int. Cl. E05C 1/10; E05B 3/00

(52) U.S. Cl. 292/162

(57) ABSTRACT

The invention discloses a sliding handle lock for door and window comprising an inner lock body and an outer lock body, which are installed respectively at each side of the door and window oppositely, an inner handle is provided at said inner lock body, an outer handle and a lock cylinder are provided at said outer lock body; further, a latch bolt lock control mechanism and a dead bolt lock control mechanism are provided at said inner lock body, said latch bolt lock control mechanism is joined with the outer handle through an elongated connectable sheath, and said dead bolt lock control mechanism is joined with the lock cylinder through an elongated connecting slip. Compared with the prior art, the present invention has the following benefits: 1. Simple in structure, fewer in parts, convenience for assembling, easy to open and close door and highly security. 2. It's convenient to change the direction of extending and retracting the latch bolt, so that it can meet the installation requirements of the sliding door and window which the door and window can be opened from various directions, i.e. inside, outside, left and right and the like, it has strong versatility and low cost. 3. It applies to the door and window with various thickness, and extends the range of application.

### FIELD OF TECHNOLOGY

The invention relates to a handle lock for door and window, which belongs to the technical field in respect of anti-theft lock for door and window, and in particular to a sliding handle lock for door and window.

### BACKGROUND

In the prior art, there are various kind of locks for door and window which have different function. The traditional locks are mortise lock and knob lock. They have a simple structure and a low cost, but also have the shortcomings, for example, the structure of the gate body must be destroyed while the mortise lock body is installed, so as to make a groove in the side wall of the gate body such that the latch bolt can be moved in and out therein. The process of which is complicate and time-consuming, and the strength of the door will be damaged. For knob lock, its body not only required to destroy the structure of the gate body, but also only have a single bolt, which provides a low security. Although existing sliding lock for door and window can be locked without any damage of the gate body, e.g., CN ZL02225564.8, its latch bolt is driven to rotate and lock by the rotational positioning of the handle, the operation for opening and closing must be conducted inside door and window. Moreover, the operating handle is needed for both opening and closing the door and window, and the operation is inconvenience. On the other hand, the existing sliding lock for door and window is generally applies to the door and window with single thickness, such that its application will be restricted.

### SUMMARY

The purposes of the present invention are overcoming the shortcomings and the deficiencies in the prior art and providing a sliding handle lock for door and window which is simple in structure, easy for assembly, safe and reliable and applicable to different thickness of door and window.

In order to realize the purposes, the present invention is achieved by the following technical solution:

A sliding handle lock for door and window, comprising an inner lock body and an outer lock body, which are installed respectively at each side of the door and window oppositely, an inner handle is provided at the inner lock body, an outer handle and a lock cylinder are provided at the outer lock body; further a latch bolt lock control mechanism and a dead bolt lock control mechanism are further provided at the inner lock body, the latch bolt lock control mechanism is joined with the outer handle through an elongated connectable sheath, and the dead bolt lock control mechanism is joined with the lock cylinder through an elongated connecting slip.

Further, the dead bolt lock control mechanism comprises a latch bolt twist component, a latch bolt component and a square rotation axis. The latch bolt twist component and the inner handle are respectively arranged at two sides of the inner lock body, they are connected and fastened through a lock screw, an upper interference protrusion and a lower interference protrusion are respectively provided at the upper and lower end of the latch bolt twist component, and a torsion spring is sheathed in the middle part of the latch bolt twist component, two end-leafs of the torsion spring are respectively contacted and associated with the inside walls of a fixed block located in the inner wall of the inner lock body, and linked by a clutch with the lower interference protrusion, and associated with the lower interference protrusion while connecting.

The latch bolt component consists of a latch bolt and a latch bolt reversing support, wherein the latch bolt reversing support is set in removably and positioned at the inner lock body, and the latch bolt are mounted in the latch bolt reversing support through a positioning screw and a return spring, which can be telescopic, and the end of the inclined plane thereof extends out of the outside of the inner lock body, a bent brace is arranged at the opposite end thereof and is associated with the upper interference protrusion of the latch bolt twist component. One end of the square rotation axis is connected and fastened to the outer handle, and the other end is associated with the latch bolt twist component by an elongated connectable sheath.

Further, one end of the elongated connectable sheath is plugged by and associated with the square rotation axis, the other end is plugged by and associated with the latch bolt twist component.

Further, the dead bolt lock control mechanism comprises a dead bolt and a dead bolt handle. The dead bolt is set movably inside the inner lock body, an irregular groove is arranged at the corner of the dead bolt, and a strip of groove is arranged at the middle of the dead bolt. The outer end of the dead bolt handle passes through out of the inner lock body and forms a handle portion, the inner end of the dead bolt handle passes through out of the strip of groove of the dead bolt and is associated with the lock cylinder through the elongated connecting slip, and is further provided with a positioning turnplate where a slide convex column is arranged, the slide convex column can stick in the irregular groove of the dead bolt and then drive the dead bolt to extend and retract.

Further, a first straight side and a second straight side are arranged at the end sides of the positioning turnplate opposite to the slide convex column, and the transition between two straight sides is smooth in arc-shape, and the dead bolt lock control mechanism further has a positioning spring leaf, the first straight side and the second straight side of the positioning turnplate are contacted and associated with the positioning spring leaf in turn respectively when the dead bolt is being extended and retracted.

Further, one end of the elongated connecting slip is provided with a plurality of the trace for breaking up.

Further, the inner lock body arranged inside the door and window is connected and fastened with the outer lock body arranged outside the door and window through cup head sub-section screws.

Further, the latch bolt lock control mechanism and the dead bolt lock control mechanism are wrapped inside the inner lock body by a plate.

Compared with the prior art, the present invention has the following benefits:

1. Simple in structure, fewer in parts, convenience for assembling, easy to open and close door and highly security.

2. It's convenient to change the direction of extending and retracting the latch bolt, so that it can meet the installation requirements of the sliding door and window which the door and window can be opened from various directions, i.e. inside, outside, left and right and the like, it has strong versatility and low cost;

3. It applies to the door and window with various thickness, and extends the range of application.

### BRIEF DESCRIPTION OF THE DRAWINGS

In order to best understand the present invention, an embodiment of the invention will be described in detail, with reference to the accompanying drawings, wherein:

FIG. 1 is an assembly schematic diagram of the present invention.

FIG. 2 is an exploded diagram of the present invention.

FIG. 3 is an assembly schematic diagram of the latch bolt component of FIG. 2.

FIG. 4 is an exploded diagram of the dead bolt lock control mechanism.

FIG. 5 is an internal structure schematic diagram of the inner lock body of FIG. 1.

FIG. 6 is a schematic diagram of the embodiment of handle lock applied to the door opened from the right side according to the present invention.

FIG. 7 is a schematic diagram of the embodiment of handle lock applied to the door opened from the left side according to the present invention.

### DETAILED DESCRIPTION

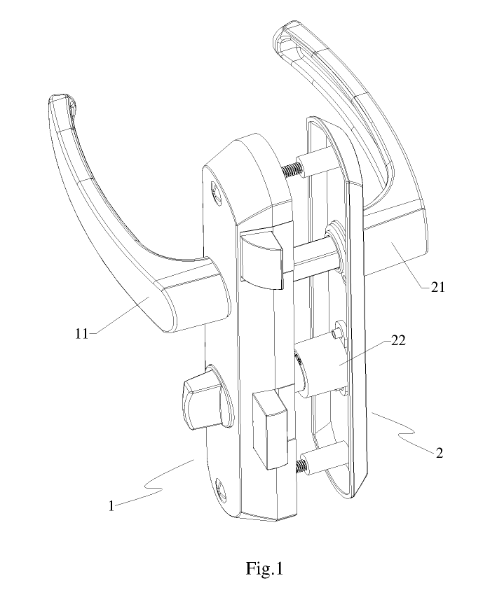

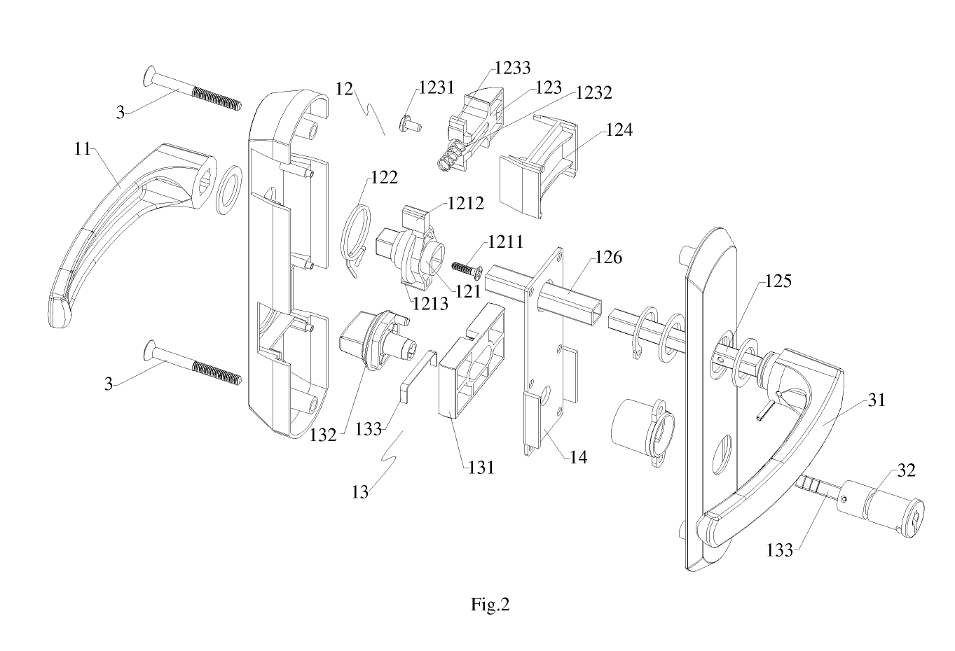

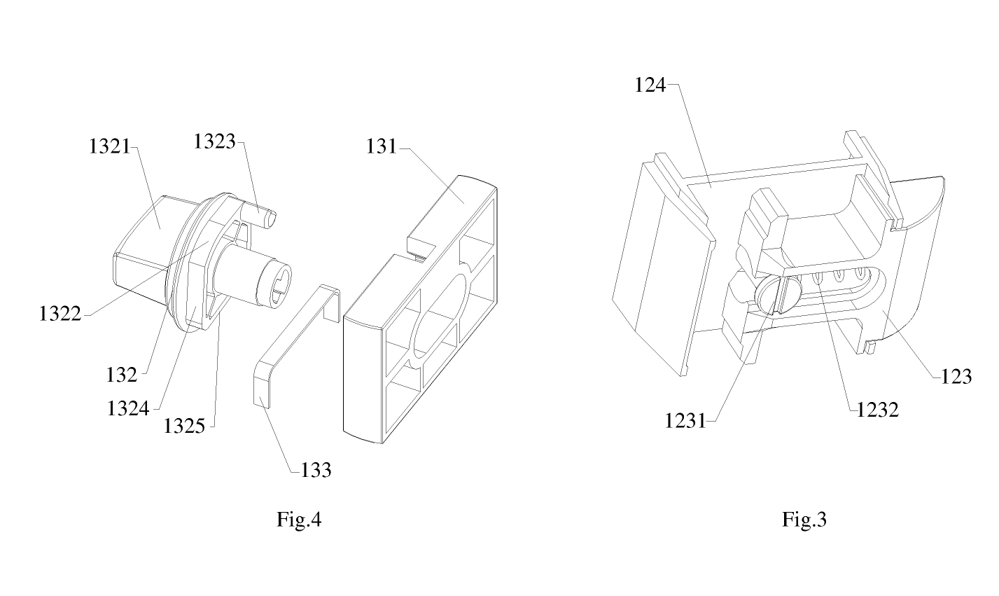

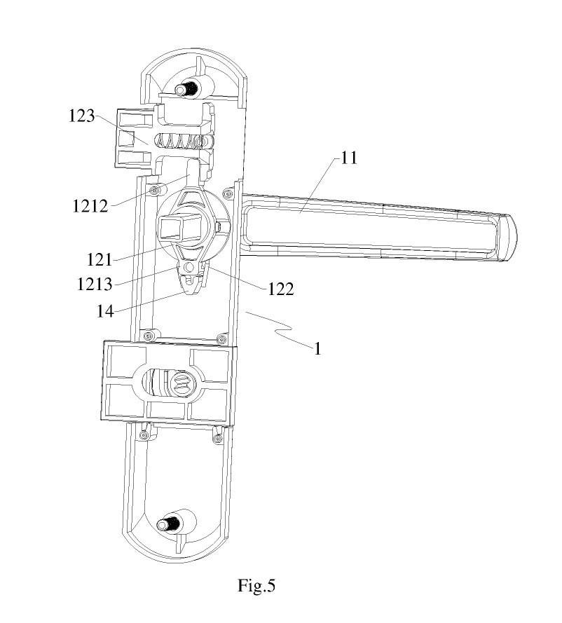

As shown in FIG. 1 to FIG. 5, a sliding handle lock for door and window of the present invention comprises an inner lock body 1 and an outer lock body 2, the inner lock body 1 arranged inside the door and window is connected and fastened with said outer lock body 2 arranged outside the door and window through cup head sub-section screws 3. an outer handle 21 and a lock cylinder 22 are provided at the outer lock body 2, and the inner lock body 1 is provided with an inner handle 11, a latch bolt lock control mechanism 12 and a dead bolt lock control mechanism 13. The latch bolt lock control mechanism 12 and the dead bolt lock control mechanism 13 are wrapped inside the inner lock body 1 by a plate 14.

The latch bolt lock control mechanism 12 comprises a latch bolt twist component 121, a latch bolt component and a square rotation axis 125. The latch bolt twist component 121 arranged inside the inner lock body 1 is connected and fastened with the inner handle 11 through a lock screw 1211. The upper and lower end of the latch bolt twist component 121 are provided with an upper interference protrusion 1212 and a lower interference protrusion 1213 respectively, and a torsion spring 122 is sheathed in the middle part of the latch bolt twist component 121. Two end-leafs of the torsion spring 122 are respectively contacted and associated with the inside walls of a fixed block 14 located in the inner wall of the inner lock body 1, and linked by a clutch with the lower interference protrusion, and associated with the lower interference protrusion 1213 while connecting. The latch bolt component consists of a latch bolt 123 and a latch bolt reversing support 124, wherein the latch bolt reversing support 124 is set in removably and positioned at the inner lock body 1, and the latch bolt 123 are mounted in the latch bolt reversing support 124 through a positioning screw 1231 and a return spring 1232, which can be telescopic. The end of the inclined plane thereof extended out of the outside of the inner lock body 1. A bent brace is arranged at the opposite end thereof and is associated with the upper interference protrusion 1212 of the latch bolt twist component. One end of the square rotation axis 125 is connected and fastened to the outer handle 21, and the other end is associated with the latch bolt twist component 121 by an elongated connectable sheath 126.

Preferably, one end part of the elongated connectable sheath 126 is plugged by and associated with the square rotation axis 125, the other end is plugged by and associated with the latch bolt twist component 121.

The dead bolt lock control mechanism 13 comprises a dead bolt 131 and a dead bolt handle 132.

The dead bolt is set movably inside the inner lock body 1, an irregular groove is arranged at the corner end of the dead bolt, and a strip of groove is arranged at the middle of the dead bolt. The outer end of the dead bolt handle passes through out of the inner lock body 1 and forms a handle portion 1321. The inner end of the dead bolt handle passes through out of the strip of groove of the dead bolt 131 and is associated with the lock cylinder 22 through the elongated connecting slip 133 which is provided with a plurality of the trace for breaking up, and is also provided with a positioning turnplate 1322 where a slide convex column 1323 is arranged, the slide convex column 1323 can stick in the irregular groove of the dead bolt 131 and then drive the dead bolt 131 to extend and retract. Preferably, a first straight side 1324 and a second straight side 1325 are arranged at the end sides of the positioning turnplate 1322 opposite to the slide convex column 1323, and transition between two straight sides is smooth in arc-shape.

The dead bolt lock control mechanism further has a positioning spring leaf 1326, the first straight side 1324 and the second straight side 1325 of the positioning turnplate 1322 are contacted and associated with the positioning spring leaf 1326 in turn respectively when the dead bolt 131 is being extended and retracted.

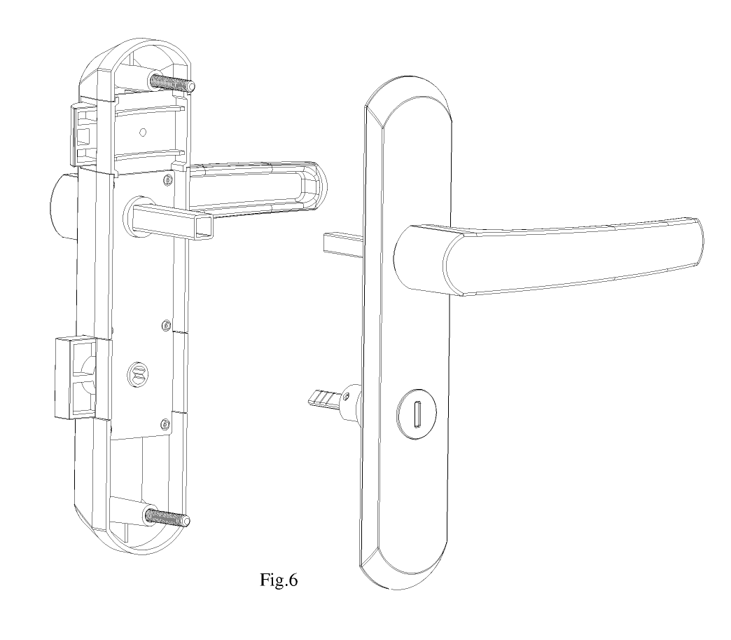

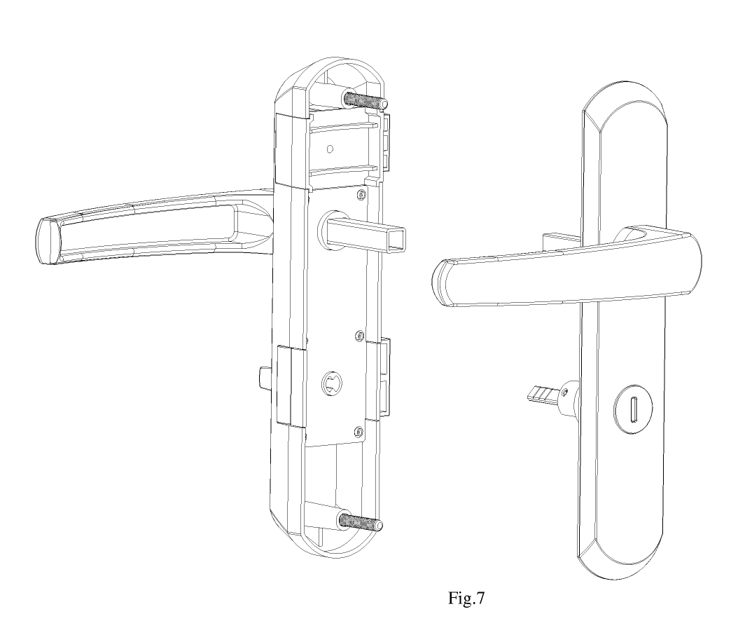

FIG. 6 is the embodiment of handle lock applied to the door and window opened from the right side. FIG. 7 is the embodiment of handle lock applied to the door and window opened from the left side. The handle may realize the conversion from the left side to the right side of the door or vice versa through a lock screw, and the latch bolt may realize the conversion from the left side to the right side of the door or vice versa through a latch bolt reversing support. The handle lock can be applicable to the door and window with various thickness by removing the overlong length of the cup head sub-section screw and the elongated connecting slip, and using the elongated connectable sheath.

When the lock is being used, the grip of the dead bolt 132 is rotated towards to the extending direction of the dead bolt 131. In the process of turning the grip of the dead bolt 132, the dead bolt 131 is driven to extend outwards gradually by the slide convex column 1323 of the positioning turnplate 1322. When the contact surface between the positioning turnplate 1322 and the positioning spring leaf 1326 run from the first straight side 1324 to the second straight side 1325, the dead bolt 131 will extend out substantially. The grip of the dead bolt 132 can be positioned quickly under the action of the positioning spring leaf 1326. Meanwhile, the dead bolt 131 will be unable to retract under any external force after it extended, due to the special shape of the irregular groove. The dead bolt 131 can be retracted quickly when operation in the opposite direction, and also can be locked or opened in the outside of the doors by the designated key. On the other hand, the latch bolt can be directly retracted by turning the inner handle or outer handle.

The invention is not limited to the above embodiments. If any changes or derivations to the invention are not separated from the spirit and the range of the present invention, and any changes and derivations belong to the claims and the equivalent technical range of the present invention, the present invention also comprises such changes and derivations.

What is claimed is:

1. A sliding handle lock for door and window, comprising an inner lock body and an outer lock body, which are installed respectively at each side of the door and window oppositely, an inner handle is provided at said inner lock body, an outer handle and a lock cylinder are provided at said outer lock body, wherein a latch bolt lock control mechanism and a dead bolt lock control mechanism are further provided at said inner lock body, said latch bolt lock control mechanism is joined with the outer handle through an elongated connectable sheath, and said dead bolt lock control mechanism is joined with said lock cylinder through an elongated connecting slip.

2. The sliding handle lock for door and window according to claim 1, wherein said dead bolt lock control mechanism comprises:
a latch bolt twist component, said latch bolt twist component and said inner handle are respectively arranged at two sides of the inner lock body, and are connected and fastened through a lock screw, an upper interference protrusion and a lower interference protrusion are respectively provided at the upper and lower end of said latch bolt twist component, and a torsion spring is sheathed in the middle part of said latch bolt twist component, two end-leafs of the torsion spring are respectively contacted and associated with the inside walls of a fixed block located in the inner wall of the inner lock body, and linked by a clutch with said lower interference protrusion, and associated with said lower interference protrusion while connecting;
a latch bolt component consisted of a latch bolt and a latch bolt reversing support, wherein said latch bolt reversing support is set in removably and positioned at the inner lock body, and said latch bolt are mounted in said latch bolt reversing support through a positioning screw and a return spring, which can be telescopic, and the end of the inclined plane thereof extends out of the outside of said inner lock body, a bent brace is arranged at the opposite end thereof and is associated with said upper interference protrusion of said latch bolt twist component; and
a square rotation axis, one end of which is connected and fastened to said outer handle, and the other end is associated with said latch bolt twist component by an elongated connectable sheath.

3. The sliding handle lock for door and window according to claim 2, wherein one end of said elongated connectable sheath is plugged by and associated with the square rotation axis, the other end is plugged by and associated with the latch bolt twist component.

4. The sliding handle lock for door and window according to claim 1, wherein said dead bolt lock control mechanism comprises:
a dead bolt set movably inside the inner lock body, an irregular groove is arranged at the corner of said dead bolt, and a strip of groove is arranged at the middle of said dead bolt;
a dead bolt handle, the outer end of said dead bolt handle passes through out of the inner lock body and forms a handle portion, the inner end of said dead bolt handle passes through out of the strip of groove of said dead bolt and is associated with the lock cylinder through said elongated connecting slip, and is further provided with a positioning turnplate where a slide convex column is arranged, said slide convex column can stick in said irregular groove of said dead bolt and then drive the dead bolt to extend and retract.

5. The sliding handle lock for door and window according to claim 4, wherein a first straight side and a second straight side are arranged at the end sides of said positioning turnplate opposite to said slide convex column, and the transition between two straight sides is smooth in arc-shape, and said dead bolt lock control mechanism further has a positioning spring leaf, said first straight side and said second straight side of said positioning turnplate are contacted and associated with said positioning spring leaf in turn respectively when said dead bolt is being extended and retracted.

6. The sliding handle lock for door and window according to claim 4, wherein one end of said elongated connecting slip is provided with a plurality of the trace for breaking up.

7. The sliding handle lock for door and window according to claim 1, wherein said inner lock body arranged inside the door and window is connected and fastened with said outer lock body arranged outside the door and window through cup head sub-section screws.

8. The sliding handle lock for door and window according to claim 1, wherein said latch bolt lock control mechanism and said dead bolt lock control mechanism are wrapped inside the inner lock body by a plate.
